(19) United States
(12) Patent Application Publication
(10) Pub. No.: US 2015/0121257 A1
(43) Pub. Date: Apr. 30, 2015

(54) METHOD AND APPARATUS FOR TRIGGERING URL LOAD REQUEST FROM A BROWSER

(71) Applicant: Samsung Electronics Co., Ltd., Gyeonggi-do (KR)

(72) Inventors: Dipin KOLLENCHERI PUTHENVEETTIL, Bangalore (IN); Joy BOSE, Bangalore (IN)

(73) Assignee: Samsung Electronics Co., Ltd.

(21) Appl. No.: 14/530,136

(22) Filed: Oct. 31, 2014

(30) Foreign Application Priority Data
Oct. 31, 2013 (IN) 4916/CHE/2013
Jul. 10, 2014 (KR) 10-2014-0086868

(51) Int. Cl. G06F 17/30; G06F 3/0482; G06F 3/0481; G06F 17/22

(52) U.S. Cl. CPC G06F 17/30899; G06F 17/2247; G06F 17/30887; G06F 3/0482; G06F 3/04817
USPC 715/760

(57) ABSTRACT

A method and apparatus that enables a user to trigger a Uniform Resource Locator (URL) load requests on one or more background tabs while displaying the current browsing webpage on the foreground tab, is provided. The method includes displaying a browsing webpage on a foreground tab of the browser, displaying a plurality of address spaces for entering URLs on the foreground tab of the browser, receiving a first URL in a first of the plurality of address spaces, opening a first background tab for the received first URL without diverting from the displayed current browsing webpage on the foreground tab, and issuing a webpage load request on the first background tab for the received first URL. The method eliminates the need to switch to a new tab to trigger one or more URL load requests in new tabs and enhances the browsing experience of the user.

### PRIORITY

This application claims priority under 35 U.S.C. §119(a) to Indian Patent Application No. IN 4916/CHE/2013, which was filed on Oct. 31, 2013 in the Government of India Office of the Controller General of Patents, Designs, and Trademarks, and Korean Patent Application No. 10-2014-0086868, which was filed on Jul. 10, 2014 in the Korean Intellectual Property Office, the entire disclosures of both of which are incorporated herein by reference.

### BACKGROUND

1. Field of the Invention

The present invention relates generally to enhancement in a browser, and more particularly, to triggering a Uniform Resource Locator (URL) load request on one or more background tabs from a foreground tab of the browser, without diverting from the current browsing webpage context.

2. Description of Related Art

Current advanced communication technology can provide round the clock internet connectivity. Accessing the interne using devices such as Personal Digital Assistants (PDAs), smart phones, tablets and laptops is common to the public (also called users) of today. Thus, recently, the use of devices necessary for accessing web services has increased exponentially.

Browsers are one of the most widely used applications on these devices. The arrival of online shopping, online banking, and social networking sites has considerably increased the usage of the browser. Often, a user using the browser opens a number of websites on the browser. At times, the user may encounter situations where he or she would require loading multiple other Uniform Resource Locators (URLs) on new tabs or new windows from the current tab or current window.

Existing browsers allow loading new webpages on new tabs or new windows in the background of the currently opened tab or window only for hyperlinks which are incorporated in a currently loaded webpage. Therefore, this cannot be performed for any given URL which the user requires to load.

With conventional methods for loading new webpages by opening new tabs or new windows from a current tab or window, the user is first required to open a new tab or a new window and then initiate the desired URL load request on the address bar of the newly opened tab or window either by typing the URL or using the bookmarks.

Some conventional methods provide multiple panes or split window techniques that divide the device screen space for allowing multiple URL entries on a single screen display. However, small screen devices such as Personal Digital Assistants (PDAs) and smart phones are unable to support conventional methods using multiple panes or split window techniques due to the small screen dimensions of such devices.

Additionally, depending on the available network bandwidth of the device and various other factors, some page-load latency exists while rendering the loading-requested web pages on the newly opened tabs. The page-load latency keeps the user waiting while loading the new page. Often the user returns back to the tab which he or she was browsing before and continues browsing it until the user finds the new webpage loaded. To know the loading progress of the new webpage the user has to frequently switch between the newly opened tabs and the current tab to check if the requested webpage has been rendered on the newly opened tabs. The conventional methods fail to provide a satisfactory user experience, especially when the user desires to trigger multiple page load requests by opening new tabs one after the other. The frequent switching between the tabs or windows may drain the battery of the device.

### SUMMARY

The present invention has been made to address at least the problems and disadvantages described above, and to provide at least the advantages described below.

Accordingly, an aspect of the present invention is to provide a method and apparatus for a user to trigger one or more Uniform Resource Locator (URL) load requests on one or more background tabs while displaying a current browsing webpage on a foreground tab of the browser.

Accordingly, another aspect of the present invention is to provide a method for a user to launch one or more applications by issuing commands corresponding to one or more applications from an address bar of the browser.

In accordance with an aspect of the present invention, a method for triggering a URL load request from a browser is provided. The method includes displaying a browsing webpage on a foreground tab of the browser, displaying a plurality of address spaces for entering URLs on the foreground tab of the browser, receiving a first URL in a first of the plurality of address spaces, opening a first background tab for the received first URL without diverting from the displayed current browsing webpage on the foreground tab, and issuing a webpage load request on the first background tab for the received first URL.

In accordance with another aspect of the present invention, an apparatus for triggering a URL load request from a browser is provided. The apparatus includes at least one processor and at least one memory having recorded thereon, a computer program. The at least one processor is configured to display a browsing webpage on a foreground tab of the browser, display a plurality of address spaces for entering URLs on the foreground tab of the browser, receive a first URL in a first of the plurality of address spaces, open a first background tab for the received first URL without diverting from the displayed current browsing webpage on the foreground tab, and issue a webpage load request on the first background tab for the received first URL.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1A illustrates a foreground tab of a browser providing a split address bar to trigger a Uniform Resource Locator (URL) load request on a background tab, according to an embodiment of the present invention;

FIG. 1B illustrates the triggered URL load request being loaded on the background tab according to embodiments of the present invention;

FIG. 2 is a flowchart illustrating the process of loading a webpage on a foreground tab and on one or more background tabs, according to an embodiment of the present invention;

FIG. 3 illustrates a browser displaying URL load requests triggered on a plurality of background tabs along with loading progress of corresponding web pages, according to an embodiment of the present invention;

FIGS. 4A and 4B illustrate launching an application by issuing commands from an address bar of a browser, according to an embodiment of the present invention;

FIG. 5A illustrates a browser providing an address bar pop up to trigger a URL load request on a background tab, according to an embodiment of the present invention;

FIG. 5B illustrates the triggered URL load request opened on the background tab, according to an embodiment of the present invention;

FIG. 6 illustrates a browser dynamically creating a plurality of address spaces by using a delimiter on an address bar of a browser to trigger a URL load request on a background tab, according to an embodiment of the present invention; and

FIG. 7 is a block diagram of an apparatus for triggering one or more URL load requests from a browser, according to an embodiment of the present invention.

### DETAILED DESCRIPTION OF EMBODIMENTS OF THE PRESENT INVENTION

Various embodiments of the present invention and the various features and advantageous details thereof are illustrated in the accompanying drawings and detailed in the following description. Throughout the drawings, like reference numerals will be understood to refer to like parts, components, and structures.

Descriptions of well-known components and processing techniques are omitted so as to not unnecessarily obscure the embodiments described herein. The examples used herein are intended merely to facilitate an understanding of ways in which the embodiments of the present invention can be practiced and to further enable those of skill in the art to practice the embodiments of the present invention. Accordingly, the examples should not be construed as limiting the scope of the present invention.

Embodiments of the present invention achieve a method and apparatus that enables a user to trigger one or more Uniform Resource Locator (URL) load requests on one or more background tabs from a foreground tab of a browser in a device without diverting from a current browsing webpage context. The browser provides a plurality of address spaces to specify a plurality of URLs on a foreground tab for triggering one or more URL load requests on one or more background tabs and a URL load request on the foreground tab. One or more address spaces for triggering one or more URL load requests on the background tab can be statically provided on the browser or can be dynamically created on the browser.

According to an embodiment of the present invention, the browser uses a split address bar mechanism that statically provides the address spaces. The split address bar mechanism splits an address bar of the browser to provide a left segment (first segment) and a right segment (second segment) on the address bar of the browser.

According to the URL load request entered by the user on the left segment of the address bar, a webpage corresponding to the URL load request entered by the user on the left segment of the address bar is opened on the foreground tab (i.e. the initially opened tab), and according to the URL load request entered by the user on the right segment of the address bar, a webpage corresponding to the URL load request entered by the user on the right segment of the address bar is opened on the background tab.

According to an embodiment of the present invention, the browser uses an address bar pop up mechanism that statically provides the address space. According to the URL load request entered by the user in an address bar pop up window, a webpage corresponding to the URL load request entered by the user is opened in the background tab, and according to the URL load request on the address bar of the current tab of the browser, a webpage corresponding to the URL load request on the address bar of the current tab of the browser is opened on the same foreground tab.

According to another embodiment of the present invention, the browser dynamically creates the address space for receiving URL load requests to be triggered on background tab whenever the user enters a certain delimiter on the address bar of the browser. In this case, the browser triggers the URL load request entered on the extreme left of the address bar on the foreground tab and triggers the URL load request entered after the delimiter on the background tab.

According to an embodiment of the present invention, any additional address bar can be provided on the foreground tab for receiving one or more URL load requests to be triggered on one or more background tabs. Additionally, the above-described tab can also be a window on the browser. The browser includes a settings menu to customize the right segment of the split address bar or the address bar pop up window to trigger a new URL load request on a new tab or a new window, when both the tab and the window are supported in the browser device environment.

The browser provided by the method also enables the user to launch an application such as device application or web application or the like from the foreground tab of the browser. The application can be launched by issuing a corresponding command in the address space, such as the right address segment, the address bar pop up window or after the delimiter in the address bar based on the mechanism implemented by the browser to provide a plurality of address spaces. On receiving the command in the new address space the browser launches the corresponding application in the foreground tab of the browser. Thus, launching of applications from the foreground tab of the browser may be possible without a need to open the menu options and the like to invoke the applications.

The browser displays a list of URL load requests triggered on one or more background tabs whenever the user performs one or more predefined actions on the right segment of the address bar of the split bar mechanism or a tab manager of the address bar pop up mechanism.

The loading progress of one or more web pages corresponding to one or more URL load requests triggered on background tabs is displayed on the foreground tab whenever the user performs the one or more predefined actions. This provides the user with the loading progress of the webpages corresponding to the background tabs without a need to switch to the background tab.

The various predefined actions performed by the user for directing the browser to perform various tasks such as displaying the URL load request list, displaying the URL loading progress, and the like, can include a tap (a gesture of shortly and lightly hitting a screen with one finger), a swipe (a gesture of moving a predetermined distance in a particular direction such as in a horizontal or vertical direction while touching a screen with one finger), a drag (a gesture of moving or scrolling a screen element), a hover (also called hovering), a gaze (also called gaze recognition), or a combination of one or more gestures and similar actions.

The browser provided according to embodiments of the present invention eliminates the need to open and switch to a new tab whenever the user desires to trigger one or more URL load requests on new tabs. The method can reduce frequent manipulation for screen switching by the user between one or more opened tabs due to factors such as page-load latency or the like. Thus, the method enhances convenience in browsing by the user.

In an embodiment of the present invention, the device can be a smart phone, a tablet, a Personal Digital Assistant (PDA), a palm top, a laptop, a personal computer or any other device with a browser.

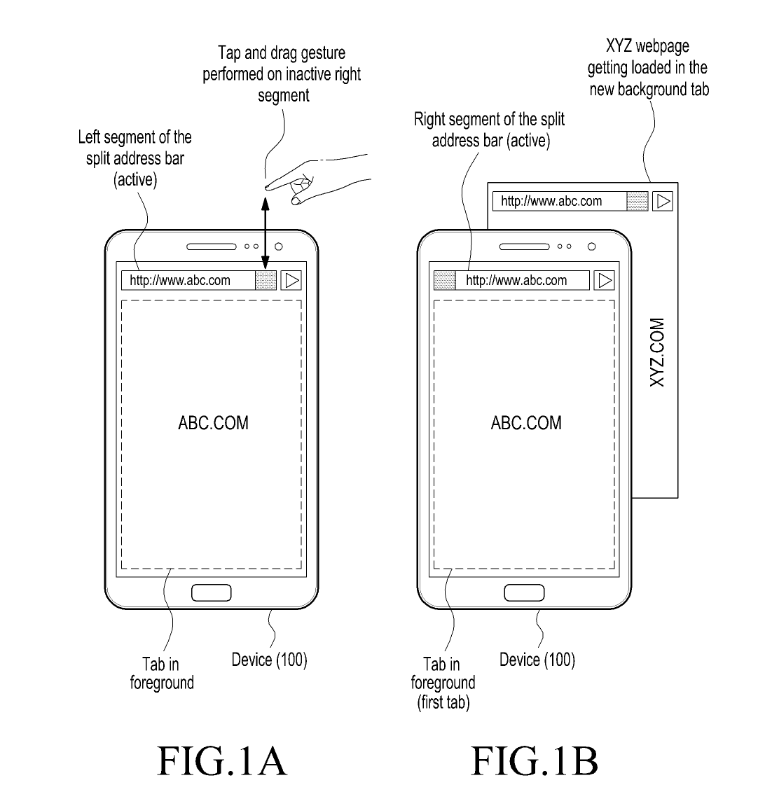

FIG. 1A illustrates a foreground tab of a browser providing a split address bar to trigger a URL load request on a background tab, according to an embodiment of the present invention, and FIG. 1B illustrates the triggered URL load request being loaded on the background tab, according to an embodiment of the present invention.

Referring to FIG. 1A, a device 100 with a browser application opened on a screen of the device is shown. The screen displays the foreground tab on the browser. The spit address bar mechanism in the browser splits or divides the address bar of the browser into a left segment and a right segment. FIG. 1A shows an inactive right segment and along with an active left segment. The URL load request for a webpage to be opened in foreground tab is triggered by the user through the active left segment. For example, a URL load request of “http://www.abc.com” entered by the user opens a corresponding web page for the entered URL in the foreground tab currently displayed on the screen. The user interested in triggering one or more URL load requests on one or more background tabs can enter one or more URL load requests by activating the right segment of the split address bar.

Referring to FIG. 1B, the user can trigger multiple URL load requests on multiple background tabs by individually entering each URL load request to be triggered on the active right segment. The activated right segment may be activated when the user performs a first predefined action such as tap and drag and the like on the inactive right segment.

FIG. 1B shows the browser displaying the active right segment which is activated when the user performs the first predefined action such as tap and drag and the like on the inactive right segment of FIG. 1A. The user can then trigger a desired URL load request on the active right segment of the split address bar according to user's manipulation.

According to an embodiment of the present invention, a webpage corresponding to a bookmark can be loaded in the foreground tab or the background tab, based on which segment of the address bar is active at the time.

On receiving the URL load request on the active right segment, the browser opens the background tab and issues a webpage load request corresponding to the URL load request triggered in the right segment. The browser automatically loads the URL load request received from the right segment of the foreground tab to the left segment of the opened background tab. For example, a URL load request of “http://www.xyz.com” triggered by the user from the foreground tab is automatically loaded in the left segment of the opened background tab. The user can continue browsing the foreground tab loaded with the “abc.com” website while the webpage for the “xyz.com” website is simultaneously loaded in the background tab by the browser.

According to various embodiments of the present invention, the browser can be configured to preset the URL in the right segment of the opened background tab. The preset URL can be the URL specified in left segment of the foreground tab. If the tab is switched from the background tab to the foreground tab, the browser can be configured to preset URL of that particular background tab in the right segment of the foreground tab. The presetting of URLs in the left segment and right segment provides the user with easy way to switch between the two tabs; the foreground tab and the background tab. The browser can be configured to preset a homepage URL of the browser in the right segment of the opened background tab. The browser can be configured to hold nothing in the right segment of the background tab by default unless opened from the foreground tab. The address bar can be configured to have one or more right segments to receive one or more URL load requests that can be triggered on one or more background tabs.

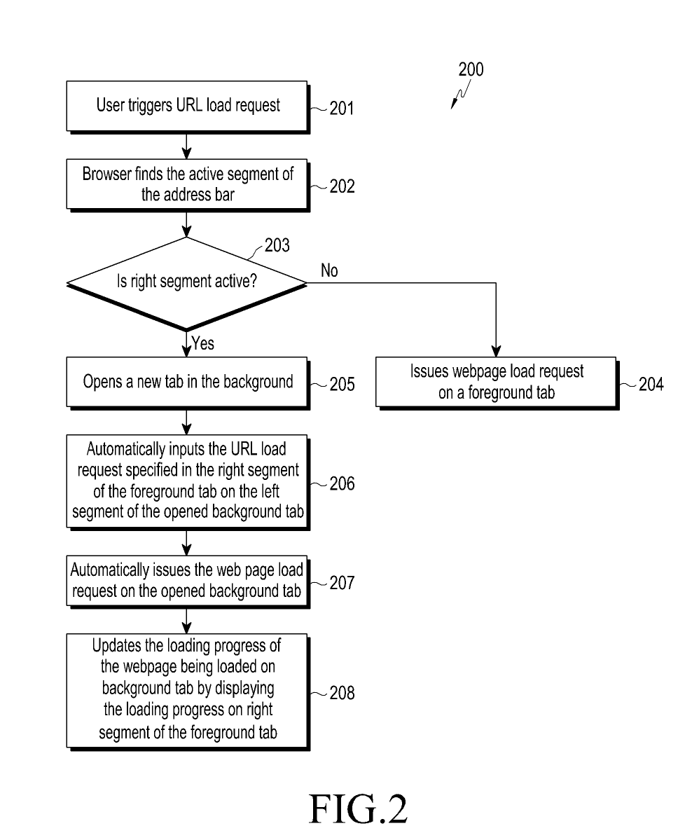

FIG. 2 is a flow diagram illustrating the process of loading a web page on a foreground tab and on one or more background tabs, according to an embodiment of the present invention.

Referring to FIG. 2, at operation 201, the user triggers the URL load request on the foreground tab of the browser. As shown in FIG. 1A and FIG. 1B, the URL load request can be triggered in either the left segment or right segment of the foreground tab by activating the desired segment provided by the split address bar mechanism. Further, at operation 202, the browser detects an active segment on the address bar which is divided into a left segment and a right segment. On detecting the active segment, at operation 203, the browser checks if the right segment of the foreground tab is active.

If the right segment is inactive, at operation 204, the browser determines that the triggered URL load request is for the foreground tab and the browser issues the webpage load request on the foreground tab. Thereafter, the webpage corresponding to the URL load request triggered on left segment is loaded on the foreground tab. For example, referring to FIG. 1A, as the right segment is inactive, and the left segment is active, the browser displays the web page corresponding to the URL “http://www.abc.com” on the foreground tab.

If at operation 203, the browser detects that the right segment on the foreground tab is active, then at operation 205, the browser opens the background tab (a new tab in the background of the foreground tab). Further, at operation 206, the browser automatically inputs the URL load request specified in the right segment of the foreground tab on left segment of the opened background tab. Thereafter, at operation 207, the browser issues the web page load request on the opened background tab. For example, referring to FIG. 1A, whenever the user activates the right segment of the foreground tab by performing the first predefined action, the browser issues the web page load request corresponding to the URL “http://www.xyz.com” on the background tab by automatically specifying the URL http://www.xyz.com in the left segment of the opened background tab. Further, at operation 208, the browser updates the loading progress of the webpage corresponding to the opened background tab to the foreground tab.

The various actions in FIG. 2 may be performed in the order presented, in a different order or simultaneously. Further, in some embodiments, some actions listed in FIG. 2 may be omitted.

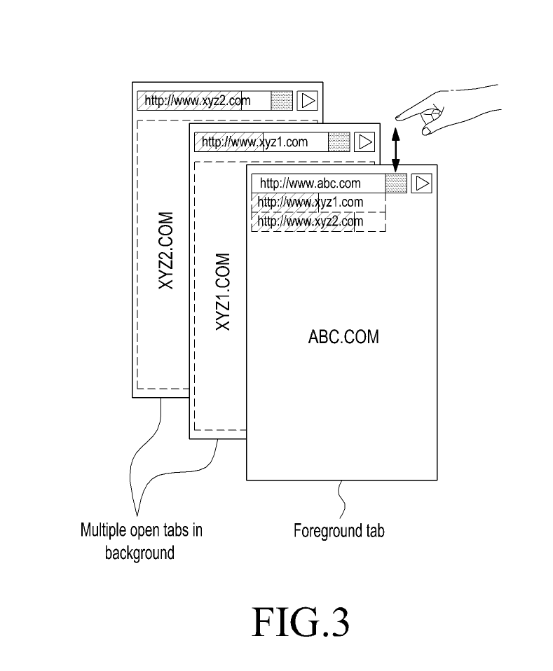

FIG. 3 illustrates the browser displaying URL load requests triggered on a plurality of background tabs along with loading progress of corresponding web pages, according to an embodiment of the present invention.

Referring to FIG. 3 multiple background tabs opened from a single (i.e., the same) foreground tab are shown. For example, FIG. 3 shows a webpage for the URL “http://www.abc.com” loaded in the foreground tab and a webpage for the URLs “http://www.xyz1.com” and “http://www.xyz2.com” being loaded in the background tabs opened from the same foreground tab. A second predefined action by the user such as tap, swipe or any similar action on the right segment displays a list of all the URL load requests associated with one or more background tabs and initiated from the same foreground tab.

Referring to FIG. 3, the loading progress according to the URL load requests is displayed on the foreground tab enabling the user to know the loading progress without individually switching to the each background tab. A third predefined action such as single tap or the like on any of the URLs on the displayed list enables the user to switch to the corresponding background tab. Thereafter, the tab (i.e., the background tab) of the URL selected according to the third action by the user is displayed on the screen of the device 100.

According to various embodiments of the present invention, the loading progress indication of the webpage is shown on the segment of the split address bar in both active and inactive state of the segment. The loading progress indication on the activated segment may be based on progress bar implementation on the split address bar itself. The loading progress indication on the inactive segment may be displayed as an actual percentage.

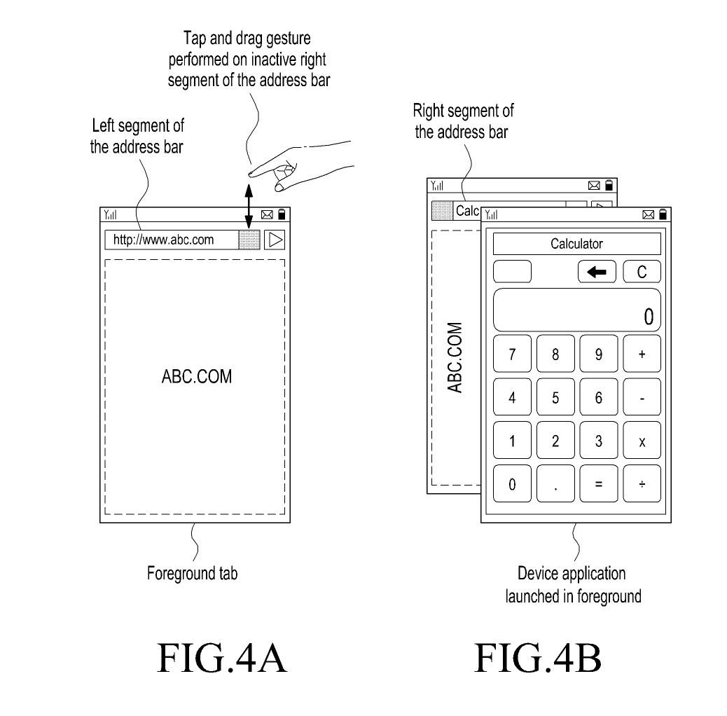

FIGS. 4A and 4B illustrates launching of an application by issuing commands from the address bar of the browser, according to embodiments of the present invention.

Referring to FIG. 4A, a screen of the device 100 displaying an initially opened tab (i.e., the foreground tab) with the active left segment of the split address bar mechanism is shown. For example, the foreground tab displays the webpage corresponding to the URL load request of “http://www.abc.com” in the left segment. According to a user's manipulation, if the right segment of FIG. 4A is activated, the browser enables the user to issue a command in the right segment of the split address bar of the foreground tab to launch a desired application. The application can be a device application, web application, or any similar application.

For example, commands may be used to launch frequently used applications quickly from the browser, without the need to switch to the application menu or the settings menu. For example, a command can be a special use-case of the Web Run Time (WRT) other than its use cases for Web Applications. The command can be achieved using the device's application launch Application Programming Interfaces (APIs) from the browser, which are implemented using the WRT. There can be one or more such commands based on use cases using the device's APIs.

Referring to FIG. 4B an example command Talc′ issued by the user in the activated right segment is shown. On receiving the command, the browser launches the calculator application in the foreground tab.

According to various embodiments of the present invention, the browser may provide a settings menu to enable the user to configure the applications and define the shortcut command to launch the respective application. The right segment of the foreground tab may be used to set a device profile to general, silent, offline, meeting, and the like, by using commands configured for the corresponding functions. The right segment may be used to set a device theme to a user preferred background, ringtone, menu style (e.g., list or grid view), and the like. The right segment may be used to set device power modes.

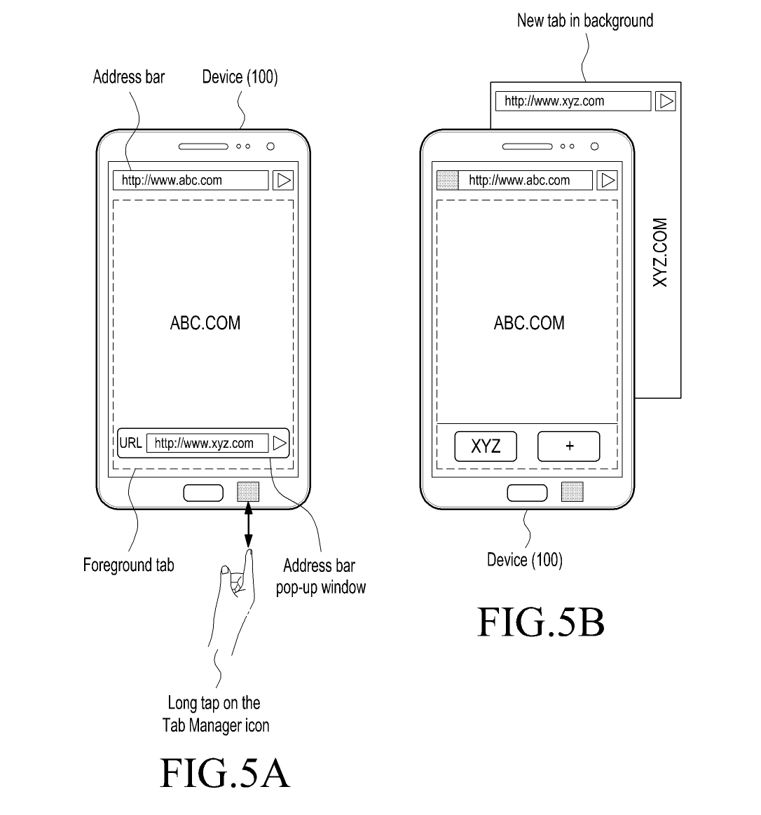

FIG. 5A illustrates a browser providing an address bar pop up to trigger a URL load request on a background tab, according to an embodiment of the present invention, and FIG. 5B illustrates the triggered URL load request opened on the background tab, according to an embodiment of the present invention.

Referring to FIG. 5A, the device 100 with a browser application opened on a screen is shown. The screen displays the foreground tab on the browser with the address bar to receive a URL load request to be triggered on the foreground tab. A tab manager icon on the browser enables the user to activate the address bar pop up window provided by the address bar pop up mechanism in the browser. The user interested in triggering one or more URL load requests from the foreground tab in one or more background tabs can activate multiple address bar popup windows and trigger desired URL load requests in each address bar popup window. The user can perform a predefined action such as a tap and drag and the like on the tab manager icon to activate the address bar pop up window. The user can activate multiple address bar popup windows to trigger multiple URL load requests on multiple background tabs.

Referring to FIG. 5B the device 100 that opens the background tab for the URL load request received in the address bar pop up window is shown. The browser issues the webpage load request corresponding to the triggered URL load request in the address bar pop up window. For example, FIG. 5B depicts a webpage corresponding to a URL request of “http://www.xyz.com” triggered from the foreground tab and opened in the background tab.

According to various embodiments of the present invention, a single tap or similar action on the tab manager icon may display a list of all URL load requests opened on the background tabs triggered from the same foreground tab. An option to open a new background tab may also be displayed along with the list of URLs. The user can then switch to the newly opened tab and specify a desired URL load request. A long or double tap gesture on the same tab manager icon may launch the address bar pop up window to trigger the URL load request and automatically open a new tab in the background.

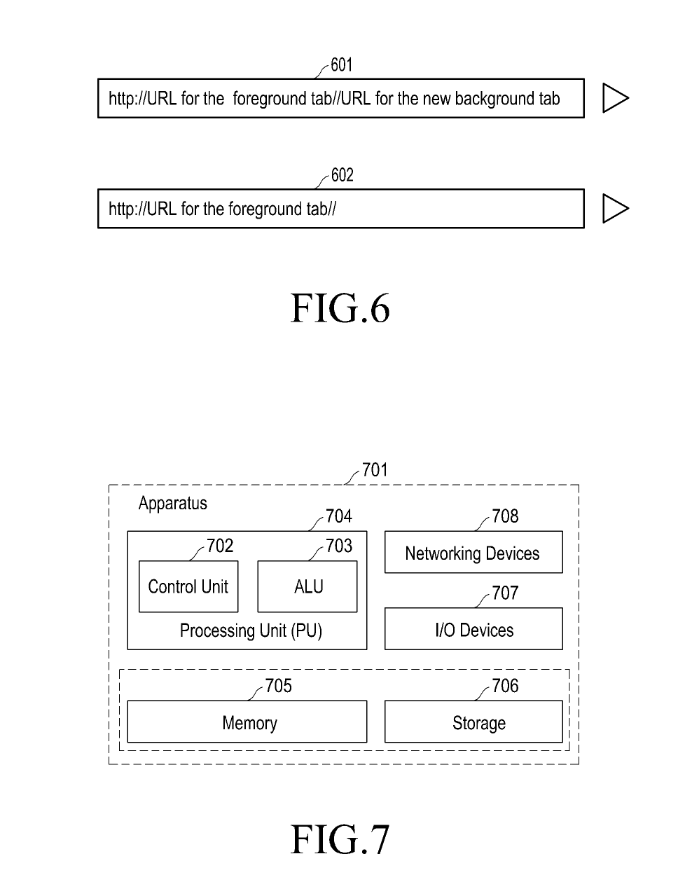

FIG. 6 illustrates a browser dynamically creating a plurality of address spaces by using a delimiter on an address bar of a browser to trigger a URL load request on a background tab, according to an embodiment of the present invention.

Referring to FIG. 6, address bar 601 of a foreground tab open on a browser is shown. The address bar of the foreground tab receives two URL load requests triggered by the user which are separated by a delimiter. The browser detects the delimiter in the address bar 601 and dynamically creates the address space to receive the second URL load request to be triggered on the background tab. The browser issues the webpage load request corresponding to the first URL load request on the extreme left of the address bar 601 to load the corresponding webpage on the foreground tab. The browser issues the webpage load request corresponding to the second URL load request on the address bar 601, entered after the delimiter, to load the corresponding webpage on the background tab.

According to various embodiments of the present invention, a double slash (//) a can be used as the delimiter. Multiple URL load requests can be triggered from the single address bar by separating each URL by the delimiter. Closing the background tab automatically removes corresponding address space that was created after the user entered the delimiter.

FIG. 6 also shows the address bar 602 of the browser, where the delimiter is not followed by any user specified URL load request. In such a scenario, the browser opens the new background tab without a specified URL. For example, as depicted in FIG. 6, if the delimiter is not followed by a URL, the browser automatically opens a new, blank background tab. The user can then switch to the newly opened tab and trigger a desired URL load request.

FIG. 7 is a block diagram of an apparatus for triggering one or more URL load requests from a browser, according to an embodiment of the present invention.

Referring to FIG. 7, an apparatus 701 for triggering one or more URL load requests from a browser includes at least one processing unit 704 that is equipped with a control unit 702 and an Arithmetic Logic Unit (ALU) 703, a memory 705, a storage unit 706, a plurality of networking devices 708, and a plurality Input/Output (I/O) devices 707. The processing unit 704 is responsible for processing the instructions of the algorithm. The processing unit 704 receives commands from the control unit in order to perform its processing. Further, any logical and arithmetic operations involved in the execution of the instructions are computed with the help of the ALU 703.

The apparatus 701 may include multiple homogeneous and/or heterogeneous cores, multiple CPUs of different kinds, special media and other accelerators. The processing unit 704 is responsible for processing the instructions of the algorithm. Further, the processing unit 704 may be located on a single chip or over multiple chips.

The algorithm including instructions and codes required for the implementation are stored in either the memory unit 705 or the storage 706 or both. At the time of execution, the instructions may be fetched from the corresponding memory 705 and/or storage 706, and executed by the processing unit 704.

For hardware implementations, various networking devices 708 or external I/O devices 707 may be connected to the apparatus 701 to support the implementation through the networking unit and the I/O device unit.

The embodiments of the present invention can be implemented through at least one software program running on at least one hardware device and performing network management functions to control the elements. The elements shown in FIGS. 1, 5, and 7 include modules which can be at least one of a hardware device, or a combination of a hardware device and software module.

With the method and apparatus for triggering an URL load request from a browser according to embodiments of the present invention, a currently browsed webpage may be displayed on a foreground tab of the browser through a user's simple manipulation, allowing the user to trigger one or more URL load requests on one or more background tabs. Moreover, by issuing commands corresponding to one or more applications from an address bar of the browser, the user may launch the one or more applications.

The foregoing description of the specific embodiments will so fully reveal the general nature of the embodiments of the present invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the present invention have been described in terms of preferred embodiments, those skilled in the art will recognize that the embodiments of the present invention can be practiced with modification within the spirit and scope of the embodiments as described herein.

What is claimed is:

1. A method for triggering a Uniform Resource Locator (URL) load request from a browser, the method comprising:
displaying a browsing webpage on a foreground tab of the browser;
displaying a plurality of address spaces for entering URLs on the foreground tab of the browser;
receiving a first URL in a first of the plurality of address spaces;
opening a first background tab for the received first URL without diverting from the displayed current browsing webpage on the foreground tab; and
issuing a webpage load request on the first background tab for the received first URL.

2. The method of claim 1, further comprising:
receiving a second URL in a second of the plurality of address spaces;
opening a second background tab for the received second URL without diverting from the displayed current browsing webpage on the foreground tab; and
issuing a webpage load request on the second background tab for the received second URL.

3. The method of claim 1, further comprising:
displaying an address space for entering a URL corresponding to the foreground tab of the browser;
receiving a third URL in the address space for entering the URL corresponding to the foreground tab; and
issuing a webpage load request on the foreground tab for the third URL load.

4. The method of claim 1, wherein the plurality of address spaces comprise one of:
a split address bar;
an address bar pop up;
an additional address bar on the foreground tab; and
an address bar of the foreground tab with a delimiter, wherein the address bar of the foreground tab with the delimiter dynamically creates the plurality of address spaces on the foreground tab.

5. The method of claim 4, wherein the split address bar provides the plurality of address spaces on the foreground tab using a first segment and at least one second segment on the address bar of the foreground tab, and
wherein the first segment receives a URL load request to be triggered on the foreground tab and the at least one second segment receives at least one URL load request to be triggered on the at least one background tab.

6. The method of claim 5, wherein the split address bar displays at least one of:
a list on the foreground tab; and
a loading progress on the foreground tab of the at least one URL load request triggered on the at least one background tab.

7. The method of claim 5, wherein the split address bar receives one of:
a preset URL; and
a blank address on at least one second segment of an address bar of the at least one background tab.

8. The method of claim 7, wherein the split address bar switches to a tab corresponding to the preset URL after the user performs the at least one predefined action on the at least one second segment.

9. The method of claim 4, wherein the address bar pop up provides the at least one address space while displaying the current browsing webpage on the foreground tab using at least one address bar pop up window on the foreground tab, and
the address bar pop up window receives the at least one URL load request to be triggered on the at least one background tab.

10. The method of claim 9, wherein the at least one address bar pop up window is displayed when the user performs at least one predefined action on a tab manager icon provided on the browser.

11. The method of claim 10, wherein the address bar pop up displays at least one of:
a list on the foreground tab; and
a loading progress on the foreground tab of the at least one URL load request triggered on the at least one background tab.

12. The method of claim 1, further comprising receiving a command in one of the plurality of address spaces to launch an application from the foreground tab.

13. An apparatus for triggering a Uniform Resource Locator (URL) load request from a browser, the apparatus comprising:
at least one processor; and
at least one memory having recorded thereon a computer program,
wherein the at least one processor is configured to:
display a browsing webpage on a foreground tab of the browser;
display a plurality of address spaces for entering URLs on the foreground tab of the browser;
receive a first URL in a first of the plurality of address spaces;
open a first background tab for the received first URL without diverting from the displayed current browsing webpage on the foreground tab; and
issue a webpage load request on the first background tab for the received first URL.

14. The apparatus of claim 13, wherein the at least one processor is further configured to:
receive a second URL in a second of the plurality of address spaces;
open a second background tab for the received second URL without diverting from the displayed current browsing webpage on the foreground tab; and
issue a webpage load request on the second background tab for the received second URL.

15. The apparatus of claim 13, wherein the at least one processor is further configured to:
display an address space for entering a URL corresponding to the foreground tab of the browser;
receive a third URL in the address space for entering the URL corresponding to the foreground tab; and
issue a webpage load request on the foreground tab for the third URL load.

16. The apparatus of claim 13, wherein the plurality of address spaces comprise one of:
a split address bar;
an address bar pop up
an additional address bar on the foreground tab; and
an address bar of the foreground tab with a delimiter, wherein the address bar of the foreground tab with the delimiter dynamically creates the plurality of address spaces on the foreground tab.

17. The apparatus of claim 16, wherein the split address bar provides the plurality of address spaces on the foreground tab using a first segment and at least one second segment on the address bar of the foreground tab, and
wherein the first segment receives a URL load request to be triggered on the foreground tab and the at least one second segment receives at least one URL load request to be triggered on the at least one background tab.

18. The apparatus of claim 17, wherein the split address bar displays at least one of:
a list on the foreground tab; and
a loading progress on the foreground tab of the at least one URL load request triggered on the at least one background tab.

19. The apparatus of claim 17, wherein the split address bar receives one of:
a preset URL; and
a blank address on at least one second segment of an address bar of the at least one background tab.

20. The apparatus of claim 19, wherein the split address bar switches to a tab corresponding to the preset URL after the user performs the at least one predefined action on the at least one second segment.

21. The apparatus of claim 16, wherein the address bar pop up provides the at least one address space while displaying the current browsing webpage on the foreground tab using at least one address bar pop up window on the foreground tab, and
the address bar pop up window receives the at least one URL load request to be triggered on the at least one background tab.

22. The apparatus of claim 21, wherein the at least one address bar pop up window is displayed when the user performs at least one predefined action on a tab manager icon provided on the browser.

23. The apparatus of claim 22, wherein the address bar pop up displays at least one of:
a list on the foreground tab; and
a loading progress on the foreground tab of the at least one URL load request triggered on the at least one background tab.

24. The apparatus of claim 13, wherein the at least one processor is further configured to receive a command in one of the plurality of address spaces to launch an application from the foreground tab.
